(19) United States
(12) Patent Application Publication
(10) Pub. No.: US 2022/0234931 A1
(43) Pub. Date: Jul. 28, 2022

(54) ULTRAPURE WATER PRODUCTION SYSTEM AND METHOD OF PRODUCING ULTRAPURE WATER

(71) Applicant: ORGANO CORPORATION, Tokyo (JP)

(72) Inventors: Fumitaka ICHIHARA, Tokyo (JP); Tsukasa KONDO, Tokyo (JP); Hiroshi SUGAWARA, Tokyo (JP); Koichiro HASHIMOTO, Tokyo (JP)

(73) Assignee: ORGANO CORPORATION, Tokyo (JP)

(21) Appl. No.: 17/613,731

(22) PCT Filed: May 22, 2020
(86) PCT No.: PCT/JP2020/020247

§ 371 Date: Nov. 23, 2021

(30) Foreign Application Priority Data
May 30, 2019 (JP) 2019-101076

(51) Int. Cl. C02F 9/00; C02F 1/42; C02F 1/44

(52) U.S. Cl. CPC C02F 9/005; C02F 2103/04; C02F 1/444; C02F 1/42

(57) ABSTRACT

Fine particles that are contained in ultrapure water supplied to a point of use is further reduced.

Ultrapure water production system has ultrapure water supply line that is connected to point of uses, wherein ultrapure water flows through ultrapure water supply line; and first ion exchange apparatus, membrane filtration apparatus and second ion exchange apparatus that are arranged in series on ultrapure water supply line. Membrane filtration apparatus is arranged between first ion exchange apparatus and second ion exchange apparatus. At least a part of the ultrapure water that flows out from membrane filtration apparatus is treated by second ion exchange apparatus before the at least a part of the ultrapure water is supplied to point of uses.

### FIELD OF THE INVENTION

The present application is based on, and claims priority from, JP2019-101076, filed on May 30, 2019, and the disclosure of which is hereby incorporated by reference herein in its entirety.

The present invention relates to an ultrapure water production system and a method of producing ultrapure water.

### BACKGROUND OF THE INVENTION

An ultrapure water production system has a subsystem that produces ultrapure water from primary pure water. In the subsystem, various apparatuses, such as a UV oxidization apparatus and an ion exchange apparatus, are arranged in series, and ultrapure water is produced by sequentially treating the primary pure water by these apparatuses. Immediately upstream of a point of use, to which ultrapure water is supplied, a membrane filtration apparatus, such as an ultrafiltration membrane apparatus, is provided in order to remove fine particles. Recently, requirement for water quality of ultrapure water has been strict, and fine particles in ultrapure water is required to be controlled at the order of 10 nm. Accordingly, requirement for membrane filtration apparatuses has also been strict. JP2018-144014 discloses washing an ultrafiltration membrane apparatus using a dedicated apparatus. JP2016-64342 discloses arranging two ultrafiltration membrane apparatuses in series.

### SUMMARY OF THE INVENTION

A membrane filtration apparatus can remove fine particles with high efficiency, but it is difficult to completely prevent fine particles from being peeled off or discharged from the membrane. In other words, fine particles upstream of a membrane filtration apparatus are captured by the membrane filtration apparatus, but because fine particles that have been captured are peeled off or because a part of the membrane itself is peeled off, fine particles may flow out to the downstream of the membrane filtration apparatus. The inventors found that while it is possible to prevent fine particles having small particle diameters of around 10 to 20 nm from flowing out, it is difficult to prevent large size fine particles having particle diameters of 100 nm or larger from flowing out. Specifically, a measurement of fine particles distribution at the outlet of a membrane filtration apparatus shows that, while fine particles having small particle diameters of around 10 to 20 nm were hardly detected, a relatively large number of fine particles having particle diameters of 20 nm or larger, especially 100 nm or larger, were detected. It is thought that this is because the membrane filtration apparatus itself works as a source of fine particles. Therefore, although the method that is described in patent document 1 is effective to some degree, it is not easy to sufficiently reduce the number of fine particles. The method that is described in patent document 2 is effective to some degree because fine particles that flow out from the upstream membrane filtration apparatus can be captured by the downstream membrane filtration apparatus. However, since fine particles that are generated in the downstream membrane filtration apparatus cannot be captured before they reach a point of use, the effect is theoretically limited.

The object of the present invention is to provide an ultrapure water production system that can further reduce fine particles that are contained in ultrapure water supplied to a point of use.

An ultrapure water production system of the present invention comprises: an ultrapure water supply line that is connected to a point of use, wherein ultrapure water flows through the ultrapure water supply line; and a first ion exchange apparatus, a membrane filtration apparatus and a second ion exchange apparatus that are arranged in series on the ultrapure water supply line. At least a part of the ultrapure water that is filtered by the membrane filtration apparatus is treated by the second ion exchange apparatus before the at least a part of the ultrapure water is supplied to the point of use.

According to the present invention, since at least a part of the ultrapure water that is filtered by the membrane filtration apparatus is treated by the second ion exchange apparatus before it is supplied to the point of use, it is possible to further reduce the fine particles that are contained in the ultrapure water supplied to a point of use.

The above and other objects, features and advantages of the present invention will become apparent from the following description with reference to the accompanying drawings which illustrate examples of the present invention.

### BRIEF DESCRIPTION OF THE DRAWINGS

FIG. 1 is a schematic diagram showing the arrangement of the ultrapure water production system according to a first embodiment of the present invention;

FIG. 2 is a schematic diagram showing the arrangement of the ultrapure water production system according to a second embodiment of the present invention;

FIG. 3 is a diagram showing the arrangement of a test apparatus that was used in the Example;

FIG. 4 is a graph showing the measurement of the number of fine particles in the Example;

FIG. 5 is a graph showing the measurement of the number of fine particles in the Example; and

FIG. 6 is a graph showing the measurement of the number of fine particles in the Example.

### DESCRIPTION OF EMBODIMENTS

### The First Embodiment

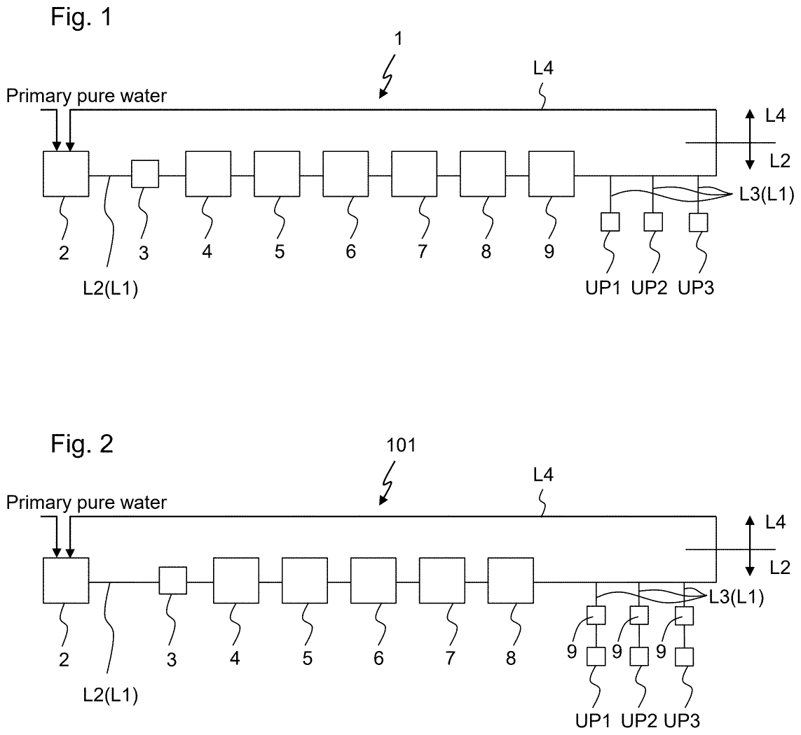

With reference to the drawings, embodiments of the present invention will now be described. FIG. 1 schematically shows the arrangement of the ultrapure water production system according to the first embodiment of the present invention. An ultrapure water production system is typically constructed from a primary pure water system that produces primary pure water from raw water, a secondary pure water system (also referred to as a subsystem) that produces ultrapure water from the primary pure water, and so on. Since the present invention is characterized by a system that produces ultrapure water from primary pure water, the description of the primary pure water system will be omitted. For convenience, a subsystem that produces ultrapure water from the primary pure water is referred to as ultrapure water production system 1 in the following description.

Ultrapure water production system 1 has sub-tank 2 that stores water to be treated (primary pure water), pump 3, heat exchanger 4, ultra-violent ray oxidization apparatus 5, first ion exchange apparatus 6, degassing membrane apparatus 7, membrane filtration apparatus 8, second ion exchange apparatus 9, and ultrapure water supply line L1 that connects these apparatuses to each other. First ion exchange apparatus 6 and second ion exchange apparatus 9 are cartridge polishers that are each charged with anion exchange resin and cation exchange resin in mixed bed, but may alternatively be electro deionization apparatuses (EDI). Ultrapure water supply line L1 includes main line L2 and branch lines L3, which branch from main line L2 and are connected to points of use UP1 to UP3. Branch lines L3 branch from respective branch points on main line L2, and are connected to respective points of use UP1 to UP3 so as to supply ultrapure water to respective points of use UP1 to UP3. Recirculating line L4 is connected to main line L2 downstream of the branch point that corresponds to the most downstream point of use (UP3 in the present embodiment) and returns the ultrapure water that has not been used at points of use UP1 to UP3 to sub-tank 2. Pump 3, heat exchanger 4, ultra-violent ray oxidization apparatus 5, first ion exchange apparatus 6, degassing membrane apparatus 7, membrane filtration apparatus 8 and second ion exchange apparatus 9 are provided in series on main line L2 in this order. Membrane filtration apparatus 8 is arranged between first ion exchange apparatus 6 and second ion exchange apparatus 9. The order in which these apparatuses 3 to 9 are arranged may be modified, as needed, depending on the requirement of water quality etc. For example, other apparatuses (for example, ultra-violent ray oxidization apparatus 5) may be arranged between first ion exchange apparatus 6 and membrane filtration apparatus 8, or between membrane filtration apparatus 8 and second ion exchange apparatus 9. A part of these apparatuses 3 to 9 may be omitted depending on the requirement of water quality etc. Although not illustrated, it is also possible to provide a first branch line that branches from main line L2 and a plurality of second branch lines that branch from the first branch line and to provide a point of use on each second branch line.

The water to be treated that is stored in sub-tank 2 is pumped by pump 3 so as to be supplied to heat exchanger 4. The water to be treated that passes through heat exchanger 4 for temperature control is then supplied to ultra-violent ray oxidization apparatus 5. Ultra-violent ray oxidization apparatus 5 radiates ultra-violent ray to the water to be treated in order to decompose organic matters in the water to be treated. Then, metallic ion and the like in the water to be treated is removed by the ion exchanging action in first ion exchange apparatus 6, and remaining oxygen is removed by degassing membrane apparatus 7. Further, fine particles in the water to be treated are removed by membrane filtration apparatus 8. Membrane filtration apparatus 8 is an ultrafiltration (UF) membrane apparatus, but may be a microfiltration (MF) membrane apparatus. The entire volume of the ultrapure water that is filtered by membrane filtration apparatus 8 is treated by second ion exchange apparatus 9 before it is supplied to points of use UP1 to UP3. A part of the ultrapure water thus produced is supplied to points of use UP1 to UP3, and the remaining ultrapure water flows through main line L2 again via recirculating line L4 and sub-tank 2.

Membrane filtration apparatus 8 efficiently captures fine particles, but fine particles may be peeled off and flow out from membrane filtration apparatus 8 itself. The fine particles are captured by second ion exchange apparatus 9 before the ultrapure water is supplied to points of use UP1 to UP3. The fine particles that are peeled off and flow out from membrane filtration apparatus 8 can be removed by the ion exchange apparatus because the fine particles usually have electric potential (the Zeta potential) on their surfaces. Fine particles in ultrapure water typically have negative electric potential (the Zeta potential) on their surfaces. However, in order also to effectively remove fine particles having positive electric potential (the Zeta potential), ion exchange resin preferably has both anion exchange resin and cation exchange resin that are put in mixed bed. Ion exchange resin in mixed bed is preferable also to maintain ultrapure water at a highly pure condition. In this manner, it is possible to effectively capture fine particles having positive electric potential and fine particles having negative electric potential and to thereby enhance the efficiency in removing fine particles. However, effect of removing fine particles can be obtained even if anion exchange resin or cation exchange resin is put in single bed. Further, since fine particles typically have negative electric potential (the Zeta potential), it is preferable that the weight ratio of anion exchange resin be larger than the weight ratio of cation exchange resin. Since the water to be treated that contains fine particles flows through gaps between resins, the resin itself functions as a physical filter, allowing fine particles to be captured not only by the electric action but also by the physical action. Second ion exchange apparatus 9 can also absorb and remove metallic components that elute from membrane filtration apparatus 8 because second ion exchange apparatus 9 can remove ion components, such as metallic ion. For these reasons, second ion exchange apparatus 9 has high capacity for removing fine particles. In the present embodiment, since any other membrane filtration apparatus is not provided between second ion exchange apparatus 9 and points of use UP1 to UP3, it is unlikely that the ultrapure water, from which fine particles are removed by second ion exchange apparatus 9, is contaminated by fine particles that are generated by other filtering apparatuses, before the ultrapure water is supplied to points of use UP1 to UP3.

Ion exchange resin is generally classified into a gel type and a macro porous type, and the ion exchange resin that is put in second ion exchange apparatus 9 is preferably a granular gel type. Fine particles may also be generated from the surface of ion exchange resin. However, since ion exchange resin of the gel type has smaller surface area than the macro porous type, the gel type can be preferably used as the ion exchange resin that is put in second ion exchange apparatus 9. The ion exchange resin includes, for example, H-type strong acid ion exchange resin and OH-type strong basic ion exchange resin. The average particle diameter of the strong acid ion exchange resin and the strong basic ion exchange resin is preferably around 500 to 800 μm. The height of the resin bed of second ion exchange apparatus 9 is preferably 10 cm or larger.

The water to be treated that is supplied to second ion exchange apparatus 9 is highly purified because it is ultrapure water. Since most of ion components are removed by first ion exchange apparatus 6 and most of fine particles are removed by membrane filtration apparatus 8, the load of second ion exchange apparatus 9 is small. Thus, the performance of second ion exchange apparatus 9 will not easily deteriorate, and ultrapure water that is highly free of fine particles can be stably obtained for a long time at the outlet of second ion exchange apparatus 9. Since second ion exchange apparatus 9 can be used for a long time, frequent maintenance is not needed. Therefore, second ion exchange apparatus 9 is preferably a non-regenerative ion exchange apparatus (a cartridge polisher). The ion exchange resin is preferably non-regenerative resin, but regenerative resin may also be used. Second ion exchange apparatus 9 is replaced when the concentration of fine particles exceeds a predetermined value at the outlet thereof, but second ion exchange apparatus 9 may also be replaced when conductivity exceeds a predetermined value.

In order to further prevent fine particles from being generated, second ion exchange apparatus 9 has an inlet of the ultrapure water above the ion exchange resin bed and an outlet of the ultrapure water below the bed. As a result, the water to be treated is fed into second ion exchange apparatus 9 downwardly or in downflow. This flow limits the movement of the ion exchange resin layer and prevents fine particles from being generated by friction between the ion exchange resins. As the water continues to be fed and the ion exchange resin is further compressed, the movement of the ion exchange resin is further limited, and the generation of fine particles can be further limited. Consequently, the function of the ion exchange resin as a physical filter is also enhanced. In the present embodiment, second ion exchange apparatus 9 is provided on ultrapure water supply line L1. Thus, irrespective of variation in the amount of the ultrapure water used at points of use UP1 to UP3, ultrapure water flows through second ion exchange apparatus 9 at a constant flow rate, and pressure that is applied to the ion exchange resin is stabilized. Accordingly, the possibility that fine particles are generated (the ion exchange resin layer is moved) can be further decreased.

When ultrapure water production system 1 mentioned above is operated, the resin is preferably washed or conditioned in advance. If the resin used to produce ultrapure water is R-Na type or R-Cl type (R means resin), and the resin is used as it is, then requirement of water quality as ultrapure water may not be satisfied due to dissociation of Na ions and Cl ions. Therefore, strong acid cation exchange resin is preferably conditioned by an acid solution, and strong basic anion exchange resin is preferably conditioned by a basic solution. Further, when R-Na type is converted into R-H type and R-Cl type is converted into R-OH type by the operations, it is desired that the ratio of R-Na type is less than 0.1% of the total number of resins that are put in second ion exchange apparatus 9, and that the ratio of R-Cl type is less than 1% of the total number of resins. In addition, before ultrapure water that is treated by second ion exchange apparatus 9 is supplied to points of use UP1 to UP3, ultrapure water is preferably fed to the ion exchange resin until reduction of TOC (total organic carbon) becomes 0.5 ppb or smaller at the outlet of second ion exchange apparatus 9. The reduction of TOC (ΔTOC) means TOC at the inlet of second ion exchange apparatus 9 subtracted by TOC at the outlet of second ion exchange apparatus 9. In order to further reduce fine particles, water is preferably fed for a further long time. For example, as described later in the Example, fine particles having particle diameter of 20 nm or larger can be reduced to 0.1 peaces/ml by continuously feeding the water at SV 300 for about 24 hours. Alternatively, it is also possible to feed ultrapure water to ion exchange resin in advance before the ion exchange resin is put in second ion exchange apparatus 9, to wash the ion exchange resin until the reduction of TOC becomes 0.5 ppb or smaller and/or the number of fine particles having particle diameter 20 nm or larger that flow out from the resin becomes 0.1 peaces/ml, and thereafter to put the ion exchange resin in second ion exchange apparatus 9.

Ion exchange resin is typically provided in order to remove ions (metallic, anion components). However, as described above, ion exchange resin can remove fine particles. It is difficult to wash or condition a filtering membrane, such as an ultrafiltration membrane (UF) and a microfiltration membrane (MF), especially at the secondary side (the outlet side) of the membrane. On the other hand, in the case of granular ion exchange resin, fine particles on the surface of the resin or in the apparatus (column) can be easily discharged by washing or conditioning. The inventors found that sufficient washing or conditioning prevents fine particles from being generated from the ion exchange resin. In the present embodiment, ultrapure water having a small number of fine particles can be easily produced by arranging second ion exchange apparatus 9 that is mainly intended to remove fine particles.

### The Second Embodiment

FIG. 2 schematically shows the arrangement of ultrapure water production system 101 according to the second embodiment of the present invention. The present embodiment is the same as the first embodiment except that second ion exchange apparatuses 9 are provided on branch lines L3 that branch from main line L2. The arrangement and effect not described here is the same as in first embodiment. Specifically, pump 3, heat exchanger 4, ultra-violent ray oxidization apparatus 5, first ion exchange apparatus 6, degassing membrane apparatus 7 and membrane filtration apparatus 8 are arranged on ultrapure water supply line L1 in this order, and second ion exchange apparatuses 9 are arranged on respective branch lines L3, which branch from main line L2, upstream of respective points of use UP1 to UP3. In the present embodiment, the capacity of each second ion exchange apparatus 9 can be optimized depending on the amount of supply (the flow rate) of ultrapure water to each point of use UP1 to UP3. Second ion exchange apparatus 9 may be omitted if the corresponding point of use does not require removing fine particles. In addition, even if any trouble occurs in one of second ion exchange apparatuses 9, influence on the supply of ultrapure water to the other points of use is avoided by isolating branch line L3 having second ion exchange apparatus 9 in trouble. Although not illustrated, it is also possible to provide a first branch line that branches from main line L2 and second branch lines that branch from the first branch line, and to provide points of use on respective second branch lines. In this case, second ion exchange apparatus 9 may be provided on first branch line, or second ion exchange apparatuses 9 may be provided on respective second branch lines between the branch points at the first branch line and the points of use.

### Example

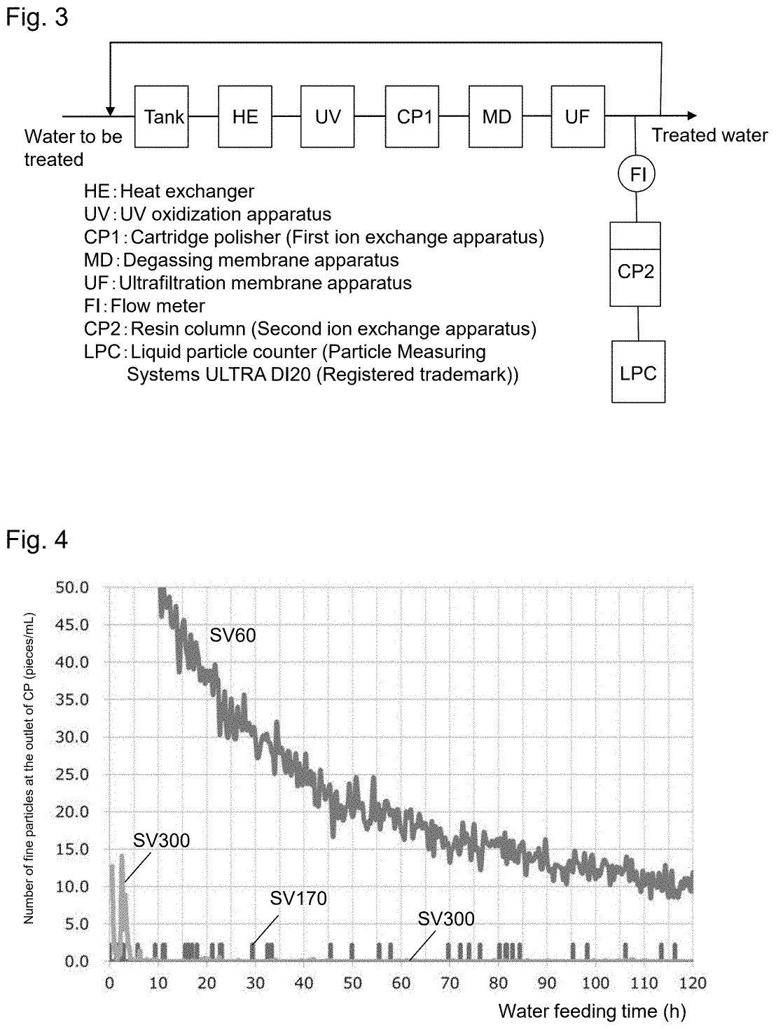

Using the test apparatus shown in FIG. 3, the performance of removing fine particles was measured. TOC was 0.6 μg/L and specific resistance was 18.2 MΩcm for both the water to be treated and the treated water. The number of fine particles having particle diameter of 20 nm or larger that are contained in the water to be treated was 0.8/mL. A resin column was used, that is made of perfluoroalkoxy alkane (PFA) having a diameter of 26 mm and a height of 500 mm, and resin (ESP-2) was put in the column in a bed height of 300 mm (hereinafter, this resin column is referred to as CP). The water to be treated (pure water) was fed to the test apparatus at SV 60, 170, 300 to wash the apparatus, and a change with time of the number of fine particles in the water at the outlet of the CP was measured. FIG. 4 shows the results. The case of SV 60 needs a very long time until the number of fine particles decreases. In the case of SV 170, fine particles are intermittently detected at intervals, but the number of fine particles was relatively stable. In the case of SV 300, the number of fine particles temporarily increased at the initial stage of the water feeding operation, but thereafter decreased sharply and substantially became zero after about 24 hours passed. Therefore, regarding the time until the number of fine particles is stabled, SV170 and 300 are preferable, while SV 60 is not preferable.

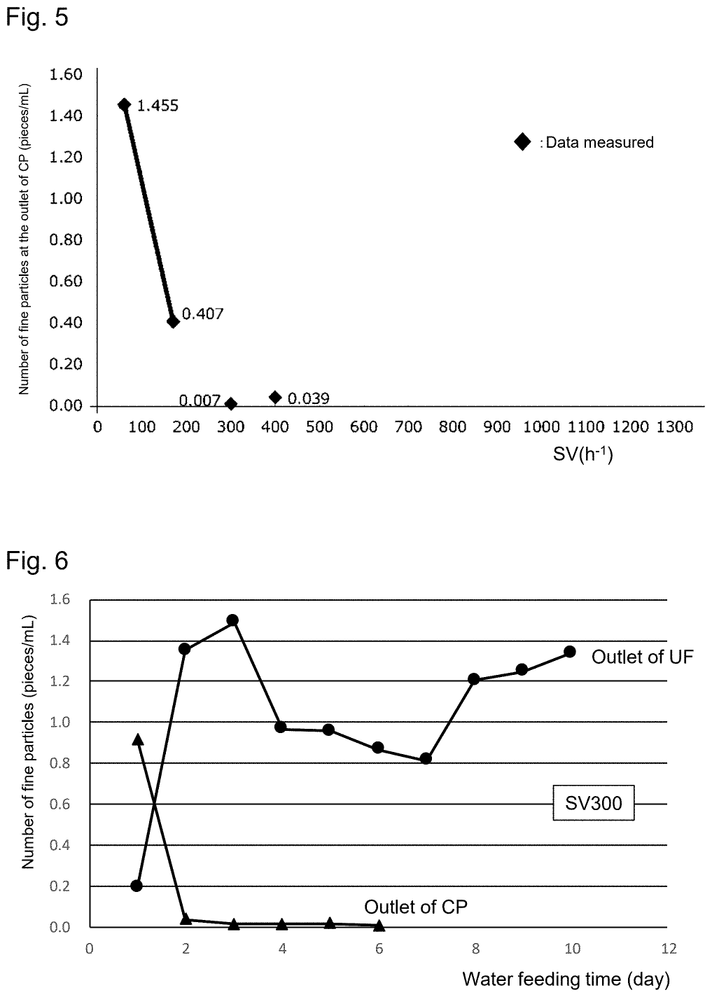

Next, the number of fine particles was measured for SV 60, 170, 300 and 400 when the number of fine particles was stabilized. FIG. 5 shows the results. In the case of SV 60, a number of fine particles of 1.4 (peaces/mL) or more was observed. In the case of SV 170, a number of fine particles of about 0.4 (peaces/mL) was observed. On the other hand, in the case of SV 300, fine particles were hardly observed, and the same result was obtained for SV 400. From the above, and taking into consideration the reduction of the number of fine particles, as well as the time needed for the reduction, SV is preferably 300 or larger.

Next, for SV=300, the change with time of the numbers of fine particles that are contained in the outlet water of the UF and the outlet water of the CP were measured. FIG. 6 shows the results. The number of fine particles is the average value of the number of fine particles (peaces/mL) that is calculated for each measurement day. For example, the number of fine particles on the first day of the water feeding operation means an average value of the number of fine particles from immediately after the start of the water feeding operation (0 hour after the start of the water feeding operation) to 24 hours after the water feeding operation started. As described above, a large number of fine particles is observed in the outlet water of the CP at the initial stage of the water feeding operation, but the average value is substantially zero on the second day and later. It is thought that this is because a small number of fine particles that had adhered to the granular ion exchange resin were discharged at the initial stage of the water feeding operation, and thereafter, fine particles were prevented from being discharged from the resin. In addition, the change (variation) in the number of fine particles was hardly observed on the second day and later. Practically, the water feeding and washing operation is considered to be completed when the average value of the number of fine particles sufficiently decreases and the measurement is stabled (the variation becomes small). Therefore, it is preferable to conduct the water feeding and washing operation for about 24 hours or more in the case of SV 300. On the other hand, the number of fine particles in the outlet water of the UF is small at the initial stage of the water feeding operation, but then increases, and thereafter keeps substantially a constant level. This shows that the peeling off of the organic matters of the UF matrix progresses as the water feeding operation continues and that the fine particles are continuously generated. As a result, the number of fine particles in the outlet water of the CP was larger than the number of fine particles in the outlet water of the UF at the initial stage of the water feeding operation, but became smaller than the number of fine particles of the outlet water of the UF on the second day. In addition, it was also confirmed that the CP captured fine particles and that fine particles are prevented from being generated from the CP itself.

Although certain preferred embodiments of the present invention have been shown and described in detail, it should be understood that various changes and modifications may be made without departing from the spirit or scope of the appended claims.

### LIST OF REFERENCE NUMERALS

1, 101 ultrapure water production system
6 first ion exchange apparatus
8 membrane filtration apparatus
9 second ion exchange apparatus
L1 ultrapure water supply line
L2 main line
L3 branch line
L4 recirculating line
UP1 to UP3 point of use

1. An ultrapure water production system comprising:
an ultrapure water supply line that supplies ultrapure water to a point of use, the ultrapure water supply line being connected to the point of use; and
a first ion exchange apparatus, a membrane filtration apparatus and a second ion exchange apparatus that are arranged in series on the ultrapure water supply line, wherein
the membrane filtration apparatus is arranged between the first ion exchange apparatus and the second ion exchange apparatus, and at least a part of the ultrapure water that flows out from the membrane filtration apparatus is treated by the second ion exchange apparatus before the at least a part of the ultrapure water is supplied to the point of use.

2. The ultrapure water production system according to claim 1, wherein
the ultrapure water supply line includes:
a main line on which the first and second ion exchange apparatuses and the membrane filtration apparatus are arranged; and
a branch line that branches from the main line and that is connected to the point of use.

3. The ultrapure water production system according to claim 1, wherein
the ultrapure water supply line includes:
a main line on which the first ion exchange apparatus and the membrane filtration apparatus are arranged; and
a branch line that branches from the main line and that is connected to the point of use, wherein
the second ion exchange apparatus is arranged on the branch line.

4. The ultrapure water production system according to claim 1, wherein any other membrane filtration apparatus is not provided between the second ion exchange apparatus and the point of use.

5. The ultrapure water production system according to claim 1, wherein the second ion exchange apparatus has a gel type ion exchange resin.

6. The ultrapure water production system according to claim 5, wherein the second ion exchange apparatus has an inlet of water to be treated above an ion exchange resin bed and an outlet of the treated water below the bed.

7. The ultrapure water production system according to claim 5, wherein the second ion exchange apparatus is a non-regenerative ion exchange apparatus.

8. A method of producing ultrapure water using an ultrapure water production system, wherein the ultrapure water production system comprises:
an ultrapure water supply line that supplies ultrapure water to a point of use, the ultrapure water supply line being connected to the point of use; and
a first ion exchange apparatus, a membrane filtration apparatus and a second ion exchange apparatus that are arranged in series on the ultrapure water supply line, and the membrane filtration apparatus is arranged between the first ion exchange apparatus and the second ion exchange apparatus, wherein
the method comprises treating at least a part of the ultrapure water by the second ion exchange apparatus before the at least a part of the ultrapure water is supplied to the point of use, wherein the at least a part of the ultrapure water is filtered by the membrane filtration apparatus.

9. The method of producing ultrapure water according to claim 8, wherein the second ion exchange apparatus has a gel type ion exchange resin,
further comprising feeding ultrapure water to the ion exchange resin before the ultrapure water that is treated by the second ion exchange apparatus is supplied to the point of use, wherein the feeding is conducted until reduction of TOC becomes 0.5 ppb or smaller at an outlet of the second ion exchange apparatus.

10. The method of producing ultrapure water according to claim 8, wherein the second ion exchange apparatus is replaced when concentration of fine particles exceeds a predetermined value at an outlet thereof.
